(19) United States
(12) Patent Application Publication
(10) Pub. No.: US 2023/0196293 A1
(43) Pub. Date: Jun. 22, 2023

(54) METHOD OF EXECUTING A PROJECT

(71) Applicant: E-VANS MANAGEMENT HOLDINGS LTD., Edmonton (CA)

(72) Inventor: Gary Evans, Edmonton (CA)

(21) Appl. No.: 18/084,171

(22) Filed: Dec. 19, 2022

Related U.S. Application Data
(60) Provisional application No. 63/291,898, filed on Dec. 20, 2021.

(51) Int. Cl. G06Q 10/10; G06Q 50/08

(52) U.S. Cl. CPC G06Q 10/103; G06Q 50/08

(57) ABSTRACT

A method of executing a project has the steps of collecting contract documents between a plurality of stakeholders involved in executing the project, the contract documents defining more than one relationship between subsets of the plurality of stakeholders, analyzing the contract documents to extract contract data, visualizing the plurality of project steps and the links relative to the plurality of stakeholders, identifying a plurality of problem-opportunity pairs (“POPs”), assigning a consequence value and an implementation value to each of the POPs, creating a plot of the POPs based on the consequence values and the implementation values, identifying a subset of the POPs to be implemented, modifying the contract data associated with a subset of the POPs to satisfy the predetermined criteria, and completing the project according to the modified contract data.

### TECHNICAL FIELD

This relates to methods of executing a project, such as a construction project, that has a plurality of stakeholders.

### BACKGROUND

Complex projects, such as construction projects, that involve multiple stakeholders are typically defined by multiple contract documents between different sets of stakeholders. As a result of these complex arrangements, deficiencies arise, which may include duplication of efforts, unassigned tasks, contradictory requirements, inconsistent definitions, etc. These deficiencies cause unnecessary delays and increased costs.

### SUMMARY

According to an aspect, there is provided a method of executing a project, the method comprising the steps of: collecting contract documents between a plurality of stakeholders involved in executing the project, the contract documents defining more than one relationship between subsets of the plurality of stakeholders, analyzing the contract documents to extract contract data, the contract data comprising: a plurality of project steps, one or more responsible stakeholder for each of the plurality of project steps, and links between adjacent project steps, visualizing the plurality of project steps and the links relative to the plurality of stakeholders, identifying a plurality of problem-opportunity pairs (“POPs”), each of the POPs comprising one or more project steps that do not meet predetermined criteria and a corresponding action to cause the one or more project steps to meet the predetermined criteria, assigning a consequence value and an implementation value to each of the POPs, create a plot of the POPs based on the consequence values and the implementation values, based on the plot, identifying a subset of the POPs to be implemented, modifying the contract data associated with a subset of the POPs to satisfy the predetermined criteria, and completing the project according to the modified contract data.

According to other aspects, the method may comprise one or more of the following features, alone or in combination: the project steps may be visualized as one of a start point, an end point, a task, a decision, a system, a milestone, a document, or a database; the predetermined criteria may be selected from a group consisting of: missing links between adjacent project steps, redundant project steps, inconsistently or incompletely defined project steps, definitions of projects steps that are contrary to local regulations or laws, unassigned project steps, missing projects steps, some or all of a project step assigned to two or more stakeholders, and project steps with improperly defined timeframes; the contract documents may be selected from a group consisting of: contracts, subcontracts, project agreements, interface agreements, contract schedules, appendices, and contract support information; the plurality of project steps and the links may be visualized using a computer program; the method may further comprise the step of analyzing background information to extract contract data, the background information being selected from a group consisting of business cases, project charters, project plans, value for money assessments, and project planning documents; the project may be a construction project, and the construction project may be constructed according to the modified contract data; the subset of POPs may be identified based on a consequence value beyond a predetermined threshold, a predetermined implementation value beyond a predetermined threshold, or a combination of a predetermined consequence value and predetermined implementation value that is beyond a predetermined threshold; and the POPS in the subset of POPs may be prioritized based on industry.

According to an aspect, there is provided a method of executing a construction project, the method comprising the steps of: collecting contract documents from a between a plurality of stakeholders involved in executing the construction project and providing the contract documents to a non-stakeholder, wherein the non-stakeholder analyzes the contract documents to extract contract data comprising: a plurality of project steps, one or more responsible stakeholder for each of the plurality of project steps, and links between adjacent project steps, visualizes the plurality of project steps and the links relative to the plurality of stakeholders, identifies problems, each problem comprising contract data that does not meet predetermined criteria, proposes an opportunity to resolve the problem to generate a list of problem-opportunity pairs (POPs), assigns a consequence value and an implementation value to each of the POPs, and creates a plot of the POPs based on the consequence values and the implementation values, and prioritizing a subset of the POPs based on the plot, modifying the contract data associated with the subset of the POPs to satisfy the predetermined criteria, and constructing the construction project according to the modified contract data.

According to other aspects, the method may comprise one or more of the following features, alone or in combination: the project steps may be visualized as one of a start point, an end point, a task, a decision, a system, a milestone, a document, or a database; the predetermined criteria may be selected from a group consisting of: missing links between adjacent project steps, redundant project steps, inconsistently or incompletely defined project steps, definitions of projects steps that are contrary to local regulations or laws, unassigned project steps, missing projects steps, some or all of a project step assigned to two or more stakeholders, and project steps with improperly defined timeframes; the contract documents may be selected from a group consisting of: contracts, subcontracts, project agreements, interface agreements, contract schedules, appendices, and contract support information; the plurality of project steps and the links may be visualized using a computer program; the method may further comprise the step of analyzing background information to extract contract data, the background information being selected from a group consisting of business cases, project charters, project plans, value for money assessments, and project planning documents; the subset of POPs may be identified based on a consequence value beyond a predetermined threshold, a predetermined implementation value beyond a predetermined threshold, or a combination of a predetermined consequence value and predetermined implementation value that is beyond a predetermined threshold; and the POPs in the subset of POPs may be prioritized based on industry.

In other aspects, the features described above may be combined together in any reasonable combination as will be recognized by those skilled in the art.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a visualization used in a method of executing a project.

FIG. 2 is a plot of problems.

FIG. 3 is a table shapes that may be used in the visualization of FIG. 1.

### DETAILED DESCRIPTION OF PREFERRED EMBODIMENTS

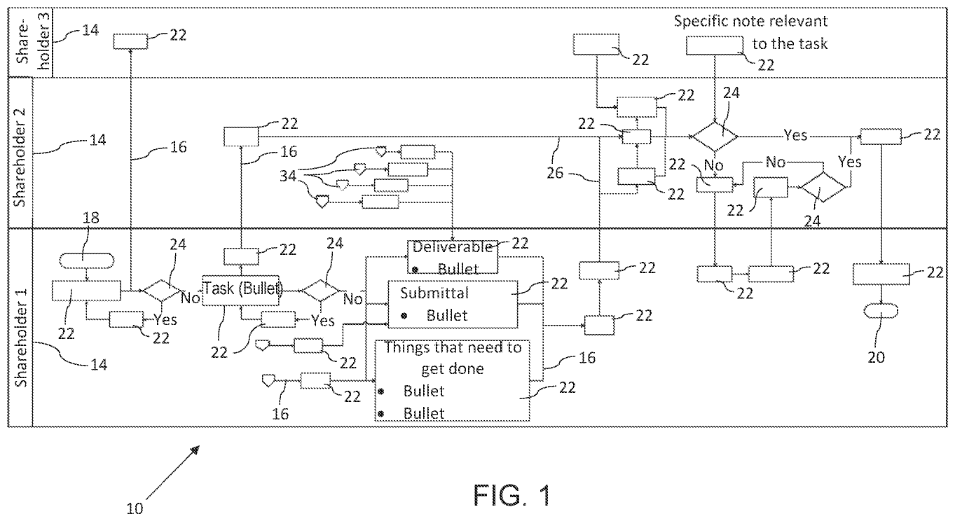

A method of executing a project, such as a construction project will now be described with reference to FIG. 1 through FIG. 3. The method is well suited for projects with a plurality of stakeholders 14 with relationships defined by multiple contract documents between the plurality of stakeholders 14, some of which may be between different subsets of the stakeholders 14. Stakeholders 14 may include groups such as owners, designers, construction contractors, construction subcontractors, financiers, lenders, consultants, special interest groups, project managers, and other third parties that have obligations under the contracts. Contract documents may include contracts, subcontracts, project agreements, interface agreements, contract schedules, appendices, and other documents that define relationships and/or obligations between stakeholders.

As a first step, contract documents are collected from the plurality of stakeholders 14 involved in executing the project. The documents are then analyzed to extract contract data. Other documents may also be analyzed to produce supplemental contract data. The other documents may include business cases, project charters, project plans, value for money assessments and other project planning documents. The collection and analysis may be conducted by one or more stakeholders 14, and/or non-stakeholders, such as one or more third parties tasked with the collection and analysis.

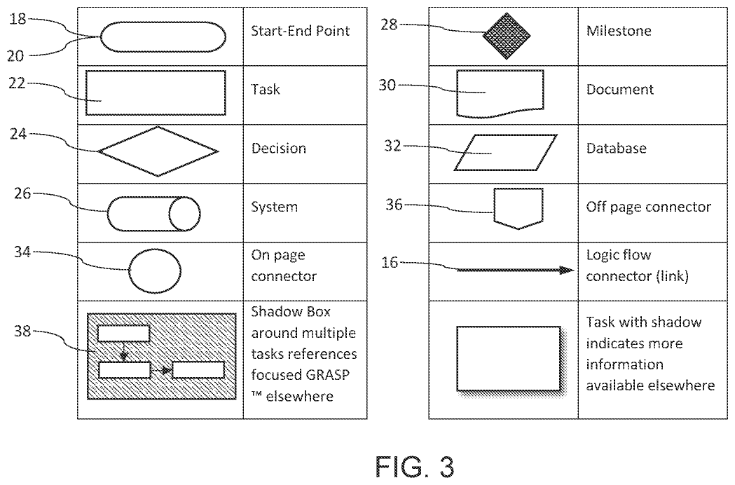

The contract data may include a plurality of project steps 12, one or more responsible stakeholders 14 for each of the plurality of project steps 12, and links 16 between adjacent project steps 12. Project steps 12 and links between project steps 12 are then visualized relative to the plurality of stakeholders 14 such as by using a visualization 10. Project steps 12 may be visualized as one of a start point 18, an end point 20, a task 22, a decision 24, a system 26, a milestone 28, a document 30, a database 32, an on-page connector 34, an off-page connector 36, or other project steps. Each of the visualized project steps 12 may have specific shapes on the visualization, such as the shapes identified in FIG. 3. The shapes in FIG. 3 are based on convention. Some shapes may be used to add information to certain tasks, such as a shadow box 38 that groups a plurality of project steps 12. Other shapes may be used, provided that the meaning of each shape is understood. Each project step 12 is visualized such that it is shown in relation to the stakeholder 14 that is responsible for the execution of that project step 12. The visualization 10 of project steps 12 and links 16 may follow a set of rules that establishes a flow of project steps 12 across the length of a project timeline. A computer program may be used for visualization 10. An example of a visualization is shown in FIG. 1.

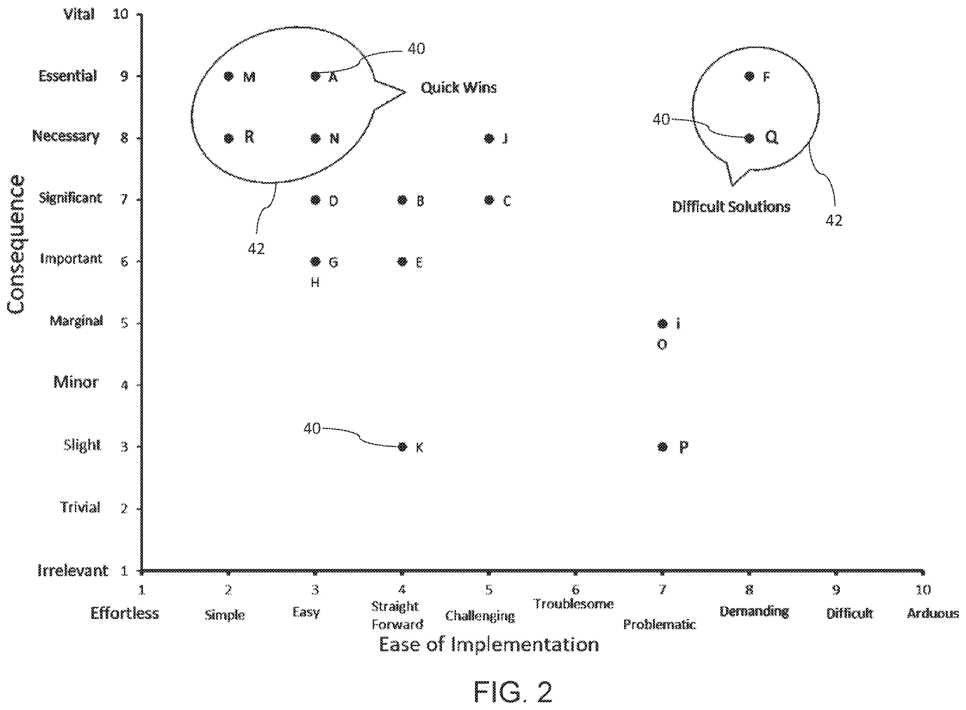

After the visualization step, problems 40 are identified. Problems 40 may include contract data that does not meet predetermined criteria, such as project steps 12 that do not have a link 16, project steps 12 that are repeated in multiple locations, inconsistent definitions of words, undefined roles & responsibilities, gaps in governance, insufficient information, or where connections between project steps 12 are unclear. For each identified problem 40, a consequence value and an implementation value are assigned. The values may be assigned on a scale of one to ten where a higher consequence value means that not addressing problem 40 will result in more severe negative consequences and a higher implementation value means that problem 40 is more difficult to address. A plot of problems 40 based on the assigned consequence and implementation values is created and is used to prioritize a subset of problems 42. The subset of problems 42 may be selected by identifying problems 40 with relatively higher consequence values and lower implementation values on the plot. The subset of problems 42 may be selected based on a predetermined threshold, such as a given consequence value, implementation value, or combination of the two. In some cases, the subset of problems 42 may include all problems 40 if they fit the selection criteria. An example of a plot of problems 40 is shown in FIG. 2.

Once identified, the subset of problems 42 is prioritized and the contract data associated with the subset of problems 42 is modified such that the contract data satisfies the predetermined criteria, and the project is completed according to the modified contract data. For example, a construction project is constructed according to the modified contract data. This may involve an amendment to the contract documents, a change order, a verbal agreement, a supplemental agreement or contract, etc.

One example of a method of competing a project in the context of a construction project will now be described.

The first task may be to source the project contract documents, such as relevant contracts, subcontracts, project agreements, interface agreements, contract schedules, appendices, and other contract support information. As background information, it may be helpful to have business cases, project charters, project plans, value for money assessments and other project planning documents.

As part of the analysis of the contracts, the contract may be scanned to determine principal content and composition.

The project stakeholders are determined and may include:
Owner Agency
Owner Engineer/Representative
Design Team (Engineer, Architect, Specialty Consultants, etc.)
Construction Contractor
Financier—if applicable (Equity financing)
Lender—if applicable (Debt financing)
Third Party—for example Independent Certifier, Safety Consultant, etc.
Other stakeholders as required or defined by the contract data

The roles/responsibilities of each stakeholder may be determined as they are defined in contract documents and may be based on standard practices for the project delivery methodology.

The project organizational structure may be determined from the contract documents and standard practices derived from the project delivery methodology. A project organizational chart may be drawn to show the highest-level relationships between stakeholders. Relationships may also be defined by additional contract documents such as an interface agreement(s).

The project life cycle may be determined and may include:
Procurement (typically not required)
Finance—if required for public-private partnership (PPP) (debt or equity—based on financial closure)
Design
Construction/Build (for infrastructure)
Installation (for operating systems)
Commissioning and Testing
Turn-Over
Operations—if required (such as for PPP)
Maintenance—if required (such as for PPP)
Hand back—if required (such as for PPP)

Project scope may be determined, such as by determining what infrastructure and operating systems are to be delivered.

Mandatory contract process(es) that are within the scope of the execution of the construction project may include:
Design
Construction (such as for infrastructure)
Installation (such as for operating systems)
Systems integration
Commissioning and testing
Turn-over
Governance
Performance/Security bond(s)
Quality specifications
Technical specifications
Payment mechanism
Project controls
Progress reporting
Scope management
Change management—Change orders
Deliverables/Submittals
Holdbacks
Liens
Safety
Freedom of Information and Protection of Privacy Act (FOIP)
Other mandatory contract process(es) as required

Optional contract process(es) that are within the scope of the execution of the construction project may include:
Leadership in Energy and Environmental Design (LEED) Certification
Environmental requirements
Penalty points system
Dispute mechanisms
Mediation/Arbitration
Indemnity
Insurance
Relief events
Warranty
Damages
Liquidated Damages
Default
Remedies
Termination
Other optional contract process(es) as required

Visualizing the plurality of project steps and the links relative to the plurality of stakeholders may be done on a visualization surface, for example on a large sheet of paper or whiteboard surface using moveable elements and may use some or all of the steps listed below. The steps are given by way of example, and modifications may be made to suit a particular situation:
Assign a colour for each stakeholder that matches the colour of an element, such as a post-it note or other devices that lend themselves to classification and are movable. These elements may be classified, moved, or modified according to the medium being used. For example, if the analysis is conducted on a whiteboard, each stakeholder may be assigned a pen colour, and may be moved by being erased and rewritten. However, it may be more convenient to write the steps and/or links on a movable element, such as by writing on a piece of paper that is temporarily secured by adhesive in its position.
Read the contract documents considering previous analysis of stakeholders (roles/responsibilities), project organizational structure, project life cycle, and project scope.
Summarize the information from the contract documents on the elements. For example, each time a stakeholder is to complete a task, document the task, such as in sentence format (noun-verb pair), on the appropriately coloured element. Reference the element to the clause in the contract. Place the element on the large sheet of paper or white board surface.
Organize the elements, which may be done as follows:
   Use decision diamonds to capture process logic where the contract diverges based on different alternatives. Apply the “If then else” logic of computer programming or answer a question with “yes/no” response to determine the divergence in logic. Decision diamonds may be colour coded to the stakeholder that is making the decision.
   Decision diamonds may also be applied to computer programming “case” logic with multiple alternatives. For example, the “case” is building vertical location and the alternatives are/below grade/main floor/floor 2-10/floor 11-30/floor 31-63/penthouse/rooftop.
   Logical loops may be represented by decision diamonds that are cyclic in nature. For example, progress reports and payment mechanisms typically occur monthly until project completion. Use decision diamonds to capture the exit logic from the loop.
   The elements may be placed on the paper in chronological order of the project from left to right.
   When visualizing the plurality of project steps and the links relative to the plurality of stakeholders conventional flow chart shapes, shown in FIG. 3, may be used.
A complete end-to-end contract analysis may be performed first. Subsets of the visualization may suggest a more detailed review, and the relevant tasks may be encircled and labelled for additional analysis.
For the first draft, it may be preferable to defer connecting some or all of the elements with lines.
The draft may then be reviewed, and the elements moved around to align similar coloured elements horizontally and place them in chronological order, such as from left to right.
Decision diamonds may be added where required.
When comfortable with the location of all elements, any missing links as lines may be drawn, indicating the flow of logic.
Areas of confusing logic may be flagged with a “question mark” elements placed closest to the occurrence on the visualization. Sources of confusing logic may include the following:
   Possible gaps in logic when there is a “floating” element that is not connected to adjacent elements, or it is unclear how to get to/from an element.
   Duplications or overlaps in logic when multiple arrows point to the same element, or the content of an element is repeated in other elements.
A problem log related to the confusing logic may be created by:
   Checking for clear consistent definitions aligned with standard practices using keyword searches (to follow process specific flows), where any missing or unclear terms/definitions are flagged for the problem log.
   Flagging areas with unclear process flow for the problem log.
   Documenting each “question mark element” in the problem log.
   To the extent possible, defining each problem in terms of the five W's and H: When does the problem occur? What happened to cause the problem? Where does the problem occur? Who is the source of the problem? Why did the problem happen? How does the problem occur?
The elements on the visualization surface may be transferred to a flowchart software package such as Microsoft VISIO.
The software version of the visualization may be edited to the most readable format to avoid backwards flow, crossing lines and entangled logic. When satisfied with the format, a hard copy of the visualization may be printed. The hard copy may require large paper sizes or cutting and pasting together multiple pages.
The visualization may be further analyzed through the following steps:
   Focusing on the vertical links between stakeholders to determine if the interfaces provide the correct information in a timely manner. Identifying further problem interfaces as “question mark elements” and summarizing them in the problem log.
   Following the process flow from beginning to end to determine if there are conflicts or misinterpretations in the logic from each stakeholder's viewpoint. Flagging these conflicts or misinterpretations and further document them in the problem log.
A final draft of the visualization is prepared.
The “question mark elements” and other problem areas are compiled into a final draft of the problem log.

Other problems may be identified based on other criteria, such as:
steps that do not have a link,
redundant steps in multiple locations,
undefined and/or inconsistent definitions of terms,
unassigned responsibilities,
gaps from tasks required for project completion but not assigned to a stakeholder, duplications from a task assigned to two or more stakeholders,
ambiguous definition of parallel or sequential tasks assigned to one or more stakeholders,
unclear timeframe for tasks without a defined start, finish, duration, and/or completion criteria,
ambiguous description of tasks or task activities,
task descriptions not applicable to the stakeholder, industry, sector, or jurisdiction of the project,
unclear dependencies between tasks and/or decision criteria, and
conflicting logic between tasks and/or decision criteria.

All or a portion of the following conventions may be used for developing the visualization:
Use and movement of moveable and/or color-coded elements on paper or white board surfaces.
Each stakeholder has a horizontal swim lane that contains all their tasks.
Keep the sentences as short as possible.
Use the conventional flow chart shapes indicated in FIG. 3.
The stakeholder with the greatest number of tasks may be on the bottom swim lane and the stakeholder with the least amount of tasks may be on the top swim lane. This typically means the construction contractor is the bottom swim lane and the owner agency is the top swim lane.
All connecting lines are one directional. Double headed arrows are not permitted.
The requirement for a double headed arrow typically means that a logical loop is required.
Tasks completed by multiple stakeholders may span multiple swim lanes. Avoid this scenario if possible, with the exception is committee meetings. Elements that span multiple swim lanes are problem log candidates.
Use on-page connectors to avoid crossing lines.
Use off-page connectors to transition to adjacent pages or sheets.
Use shadow boxes to encircle areas on a higher-level visualization that are expanded in detail on a focused visualization. Ensure that focused visualization have logical start-end connections that link to the higher-level visualization.
For focused visualization the recommended best practice is to slightly exceed the scope boundaries of the focused visualization to incorporate valuable context.

The draft visualization diagram may then be reviewed, and the problem log may be supplemented based on other considerations, such as:
What the source agency wants may differ from what the contract requests.
What the construction contractor can or will provide may be based on their interpretation of the contract document. Each construction contractor may not have the relevant experience, skills, talents, and abilities to fulfil the contract requirements.
Project specific knowledge may expose gaps when compared to best practices within the industry.
Viewing the contract documents from a process or system perspective may uncover oversights in the original contract document that are added to the problem log.
The interface between stakeholders may be reviewed for communication issues for new items in the problem log.

For each problem, opportunities for improvement may be considered and documented how the opportunity would solve the problem. Note that the opportunities are not considered solutions. The problem log may be updated with the opportunities to create a list of Problem—Opportunity Pairs (POP), based on the identified problems, and proposed opportunities to address the problem. These Problem—Opportunity Pairs (POP) may include terminology, governance, roles & responsibilities, payment mechanism, submittals, schedule, milestones, deliverables, completion certificates (design/construction/commissioning/safety), systems integration, testing, commissioning, turn-over, operations, maintenance, etc. The findings are then summarized in a POP register.

Each problem may be assigned a value on a scale of 1 to 10 and plotted on two axis—implementation and consequence. As outlined in Table 1 below, on the implementation scale, 1 may represent effortless while 10 is arduous, and on the consequence scale, 1 may represent irrelevant while 10 represents critical/vital to the project success.

TABLE 1
Implementation and consequence scales

| | |
|---|---|
| Implementation | Consequence |

| | | | |
|---|---|---|---|
| 1 | Effortless | 1 | Irrelevant |
| 2 | Simple | 2 | Trivial |
| 3 | Easy | 3 | Slight |
| 4 | Straight Forward | 4 | Minor |
| 5 | Challenging | 5 | Marginal |
| 6 | Troublesome | 6 | Important |
| 7 | Problematic | 7 | Significant |
| 8 | Demanding | 8 | Necessary |
| 9 | Difficult | 9 | Essential |
| 10 | Arduous | 10 | Vital - Critical |

The implementation and consequence scales outlined above may also be determined based on predetermined criteria. For example, each of the implementation and consequence scale may be based on predefined factors, with each factor being represented in an algorithm or assigned a quantitative value. For example, the implementation number may be based on the number of manhours, number of parties involved, level of seniority required for approval, etc. and the consequence scale may be based on impact on other steps, the return on investment, the delay caused by a failure to complete, etc. The POP register may be reviewed to find easy to implement (quick win) POP that are significant to project success. In the same manner there may be POP that are critical to project success that must be implemented despite the high degree of difficulty (difficult solutions).

A report that includes the visualization and POP may be provided to the relevant stakeholder group for review and comment.

The final report may lead to a robust dialogue with and/or between stakeholders on the merit of each POP. These discussions may occur independently or in a workshop environment and may focus on individual or multiple POP.

The outcome of the discussions is to develop each POP into a solution. Some solutions will be self-evident while others will require significant resources, time, and effort to build agreement amongst stakeholders. Reaching resolution may range from straightforward agreement, to negotiated dialogue, to facilitated workshops, to mediation techniques, to value engineering analysis.

The visualization, POP and solutions may be assembled into an action plan.

Portions of the method described above may be done by software, such as:
Model the project process flow for visualizations.
Facilitate the information required to move from problem to opportunity to solution.
Document each problem and potential solution.
Develop an Action Plan.
Enable role playing for individual or group of stakeholders simulating a project environment over some or all the project life cycle.
Output project scenarios based on stakeholders decisions.

The last step is for the stakeholders to construct the construction project based on the action plan for each solution in order of priority.

The method may be applied to Engineering Procurement Construction (EPC) project delivery methods such as Traditional (Design—Bid—Build), Design—Build, Construction Management, Public—Private—Partnerships (PPP or P3), Integrated Project Delivery, and Alliance Model.

The method may be applied before or during a construction project life cycle. One approach would be to use the method after drafting the contract but before starting the project. The method may be used mid-project for root cause analysis in support of conflict or dispute resolution. The method may be used after completion of a project for claim resolution or to provide valuable lessons learned for future projects.

The method may be applied to individual or multiple stakeholders including but not be limited to the owner agency, engineers, architect, design professionals, general contractors, construction team, sub-contractors, partnership(s), joint ventures, financiers, lenders, independent agents, operator, maintainer, or third parties.

The method may be applied to components of the contract such as definitions—terminology, roles & responsibilities, process flow, governance, steering committees, communication protocols, approval documents, requirements, deliverables, completion certificates (design/construction/commissioning/safety), procedures, workflow, schedule, timeframe, sequencing, milestones, deadlines, budget, project monitoring—controls, risk management, document control, quality control, information systems, payment mechanism, and submittals to name a few.

Within a PPP environment, the method may be used for business case development, market sounding, value for money assessment, phased procurement, commercial closure, financial closure, and risk allocation—transfer plus the other project phases mentioned previously.

In other examples, similar principles may be applied to other business contracts other than the construction project environment and may be applied to other business contracts that involve multiple stakeholders and complex contract documents. The greater the complexity, words, terms, conditions, and clauses within the contract, the greater the benefit from the method described herein in clarifying the roles of contract parties, understanding contract processes, and performing the requirements of the contract.

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The scope of the following claims should not be limited by the preferred embodiments set forth in the examples above and in the drawings, but should be given the broadest interpretation consistent with the description as a whole.

What is claimed is:

1. A method of executing a project, the method comprising the steps of:
collecting contract documents between a plurality of stakeholders involved in executing the project, the contract documents defining more than one relationship between subsets of the plurality of stakeholders;
analyzing the contract documents to extract contract data, the contract data comprising:
a plurality of project steps;
one or more responsible stakeholder for each of the plurality of project steps; and
links between adjacent project steps;
visualizing the plurality of project steps and the links relative to the plurality of stakeholders;
identifying a plurality of problem-opportunity pairs (“POPs”), each of the POPs comprising one or more project steps that do not meet predetermined criteria and a corresponding action to cause the one or more project steps to meet the predetermined criteria;
assigning a consequence value and an implementation value to each of the POPs;
creating a plot of the POPs based on the consequence values and the implementation values;
based on the plot, identifying a subset of the POPs to be implemented;
modifying the contract data associated with a subset of the POPs to satisfy the predetermined criteria; and
completing the project according to the modified contract data.

2. The method of claim 1, wherein the project steps are visualized as one of a start point, an end point, a task, a decision, a system, a milestone, a document, or a database.

3. The method of claim 1, wherein the predetermined criteria are selected from a group consisting of:
missing links between adjacent project steps;
redundant project steps;
inconsistently or incompletely defined project steps;
definitions of projects steps that are contrary to local regulations or laws;
unassigned project steps;
missing projects steps;
some or all of a project step assigned to two or more stakeholders; and
project steps with improperly defined timeframes.

4. The method of claim 1, wherein the contract documents are selected from a group consisting of: contracts, subcontracts, project agreements, interface agreements, contract schedules, appendices, and contract support information.

5. The method of claim 1, wherein the plurality of project steps and the links are visualized using a computer program.

6. The method of claim 1, further comprising the step of analyzing background information to extract contract data, the background information being selected from a group consisting of business cases, project charters, project plans, value for money assessments, and project planning documents.

7. The method of claim 1, wherein the project is a construction project, and the construction project is constructed according to the modified contract data.

8. The method of claim 1, wherein the subset of POPs are identified based on a consequence value beyond a predetermined threshold, a predetermined implementation value beyond a predetermined threshold, or a combination of a predetermined consequence value and predetermined implementation value that is beyond a predetermined threshold.

9. The method of claim 1, wherein the POPS in the subset of POPs are prioritized based on industry.

10. A method of executing a construction project, the method comprising the steps of:
collecting contract documents from a between a plurality of stakeholders involved in executing the construction project and providing the contract documents to a non-stakeholder, wherein the non-stakeholder:
analyzes the contract documents to extract contract data comprising:
a plurality of project steps;
one or more responsible stakeholder for each of the plurality of project steps; and
links between adjacent project steps;
visualizes the plurality of project steps and the links relative to the plurality of stakeholders;
identifies problems, each problem comprising contract data that does not meet predetermined criteria;
proposes an opportunity to resolve the problem to generate a list of problem-opportunity pairs (POPs);
assigns a consequence value and an implementation value to each of the POPs; and
creates a plot of the POPs based on the consequence values and the implementation values; and
prioritizing a subset of the POPs based on the plot;
modifying the contract data associated with the subset of the POPs to satisfy the predetermined criteria; and
constructing the construction project according to the modified contract data.

11. The method of claim 1, wherein the project steps are visualized as one of a start point, an end point, a task, a decision, a system, a milestone, a document, or a database.

12. The method of claim 1, wherein the predetermined criteria are selected from a group consisting of:
missing links between adjacent project steps;
redundant project steps;
inconsistently or incompletely defined project steps;
definitions of projects steps that are contrary to local regulations or laws;
unassigned project steps;
missing projects steps;
some or all of a project step assigned to two or more stakeholders; and
project steps with improperly defined timeframes.

13. The method of claim 10, wherein the contract documents are selected from a group consisting of: contracts, subcontracts, project agreements, interface agreements, contract schedules, appendices, and contract support information.

14. The method of claim 10, wherein the plurality of project steps and the links are visualized using a computer program.

15. The method of claim 10, further comprising the step of analyzing background information to extract contract data, the background information being selected from a group consisting of business cases, project charters, project plans, value for money assessments, and project planning documents.

16. The method of claim 10, wherein the subset of POPs are identified based on a consequence value beyond a predetermined threshold, a predetermined implementation value beyond a predetermined threshold, or a combination of a predetermined consequence value and predetermined implementation value that is beyond a predetermined threshold.

17. The method of claim 10, wherein the POPs in the subset of POPs are prioritized based on industry.
